(19) United States
(12) Patent Application Publication
(10) Pub. No.: US 2001/0029718 A1
(43) Pub. Date: Oct. 18, 2001

(54) Interior wall and ceiling covering

(76) Inventors: Darryl L. Snyder, Canton, OH (US); Joseph M. Sokol, Akron, OH (US)

Correspondence Address: Fred H. Zollinger, lll, SAND & SEBOLT, Aston Park Professional Center, 4801 Dressler Rd., NW, Suite 194, Canton, OH, 44718-3669, US

(21) Appl. No.: 09/746,957

(22) Filed: Dec. 22, 2000

Related U.S. Application Data
(60) Provisional application No. 60/173,447, filed on Dec. 29, 1999.

(51) Int. Cl. E06B 3/54

(52) U.S. Cl. 52/474; 52/483.1; 52/506.04

(57) ABSTRACT

Wall covering panels of the invention are fabricated from a corrugated cardboard material that is treated with a fire retardant. The panel may include scored edges that ease installation. In one embodiment, the panels are folded accordion-style so that the user may cut lengths as needed. A scoring tool is provided to score lines on the panels. Another embodiment includes two corrugation layers. In another embodiment, the panel includes an interior corrugation layer that is secured by an adhesive to liner boards. Each liner board is adhered to an aluminum layer. Each liner board may be treated with a fire proof treating on its outer surface. The treated boards and aluminum layers make the panel resistant to fire.

### CROSS REFERENCE TO RELATED APPLICATIONS

This application claims priority from U.S. Provisional Patent Application Ser. No. 60/173,447 filed Dec. 29, 1999; the disclosures of which are incorporated herein by reference.

### BACKGROUND OF THE INVENTION

1. Technical Field

The present invention generally relates to interior wall and ceiling coverings and, more particularly, to an interior wall or ceiling covering fabricated from corrugated cardboard. Specifically, the present invention relates to a corrugated cardboard product for interior spaces such as crawl spaces, closets, attics, basements, and garages that may be used as an alternative to drywall. The product includes flame, smoke, water, and moisture resistant capabilities allowing it to be used in dwellings.

2. Background Information

One of the most prevalent types of interior wall and ceiling coverings used today is drywall. Drywall is a gypsum and paper product that is supplied in various sizes. The proper installation of drywall provides an inexpensive covering that results in a smooth clean wall or ceiling surface that may be painted or wall papered. The proper installation of drywall is, however, labor intensive, messy, and time consuming. Drywall sheets are relatively heavy. Two or more people are typically required to hang each drywall sheet. Ceilings are especially difficult, often requiring special tools that hold the drywall sheets in place while they are screwed to the studs. Drywall sheets are hung with screws that must be driven into the support stud and countersunk until the screw head is just below the surface of the drywall but not countersunk so far into the drywall to lose its grip on the drywall sheets. After hanging the drywall sheets, the installers must tape all the joints so that they can smooth the joints to create a seamless finish. The installers then apply drywall mud to the joints and the screw holes and allow the mud to dry. A plurality of a sanding and mudding steps then occur until the drywall is perfectly smooth and seamless. This process may last several days and create large amounts of dust during the sanding steps. The dust is very fine and difficult to clean.

For these reasons, most home owners (and home builders) will not hang dry wall on the interior of a garage, a utility room, a crawl space, an attic, or a basement. These areas are typically left with no wall or ceiling covering leaving the studs exposed. Exposed studs readily collect dirt and cobwebs. This is especially true for basement ceilings. Over time, such as in older homes, the walls having exposed studs become very dirty and unsightly. There are also typically electrical wires, gas lines, heating ducts, water lines, and phone lines hung in the ceiling and in the wall. It is thus desired in the art to provide an easy, inexpensive, and consumer-friendly method of covering these surfaces.

Drywall sheets are also relatively difficult to store in retail environments. The drywall sheets will warp when stored on end and will collect dirt when stored flat. Drywall sheets also are relatively easy to break. Broken drywall sheets cannot be repaired and must be sold at a discount.

Another problem with drywall sheets is that they do not easily fit into the standard family vehicle. Their size makes them difficult for the weekend home repair man to transport drywall sheets from a store to the house. It is thus desired in the art to provide a wall covering that is easy to store and display in the retail environment and is easy for the consumer to transport.

One problem with wall coverings is that essentially all building codes require wall coverings to meet a flame spread test. Drywall easily meets the flame spread test because it is fabricated primarily from gypsum. Substitute wall coverings must also be fire resistant to meet building codes.

### SUMMARY OF THE INVENTION

The invention provides a corrugated cardboard wall covering panel that may be used to cover bare studs in a room. The panel is treated with a fire retardant. The panels may have scored edges that may be readily folded to ease the installation of the panels. The panels may be installed with simple connectors such as staples.

The invention also provides a wall covering material that is provided to the customer in accordion form so that the customer may cut the covering to length as needed. One edge of the covering may be scored for easy installation.

The invention also provides a wall covering panel that includes two corrugated layers. The panels are abutted against each other with joint cover members being placed over the joints between the panels.

The invention further provides a wall covering panel having a corrugation layer and a pair of liner boards connected to aluminum layers.

The invention also provides a tool used to score the panels.

### BRIEF DESCRIPTION OF THE DRAWINGS

FIG. 1 is a perspective view of one corner of a room utilizing the wall covering product of the first embodiment of the present invention.

FIG. 2 is a side elevational view of the wall covering product of the first embodiment of the present invention.

FIG. 2A is an enlarged view of the encircled portion of FIG. 2.

FIG. 3 is a front elevational view of FIG. 2.

FIG. 3A is an enlarged view of the encircled portion of FIG. 3.

FIG. 4 is a perspective view of one corner of the room of FIG. 1 with the floor and wall covering products broken away.

FIG. 5 is a view taken along line 5-5 of FIG. 1.

FIG. 5A is an enlarged view of the encircled portion of FIG. 5.

FIG. 6 is a view taken along line 6-6 of FIG. 1.

FIG. 6A is an enlarged view of the encircled portion of FIG. 6.

FIG. 7 is a view taken along line 7-7 of FIG. 1.

FIG. 7A is an enlarged view of the encircled portion of FIG. 7.

FIG. 8 is a view of a second embodiment of the wall covering of the present invention.

FIG. 8A is an enlarged view of the encircled portion of FIG. 8.

FIG. 9 is a perspective view of an interior room using the wall covering of the second embodiment of the invention.

FIG. 9A is an enlarged view of the encircled portion of FIG. 9.

FIG. 10 is a perspective view of a box in which the second embodiment of the wall covering is sold.

FIG. 11 is a perspective view of a third embodiment of the wall covering of the present invention.

FIG. 11A is an enlarged view of the encircled portion of FIG. 11.

FIG. 12 is a view of a joint between two sections of the wall covering with a cover strip disposed over the joint.

FIG. 12A is an enlarged view of the encircled portion of FIG. 12.

FIG. 13 is a top view showing a cover strip disposed over an overlap joint.

FIG. 14 is a top view of a cover strip disposed over an overlap joint at an outside corner.

FIG. 15 is a top view of a cover strip used at an outside corner.

FIG. 16 is a top view of a cover strip used at an inside corner.

FIG. 17 is a top view of a cover strip used at an inside corner having an overlap joint.

FIG. 18 is an enlarged end view of a fourth embodiment of the wall covering product of the present invention.

FIG. 19 is a perspective view of a scoring tool to be used with the wall and ceiling covering product of the present invention.

FIG. 20 is an end view of the scoring tool of FIG. 19.

Similar numbers refer to similar parts throughout the specification.

### DESCRIPTION OF THE PREFERRED EMBODIMENTS

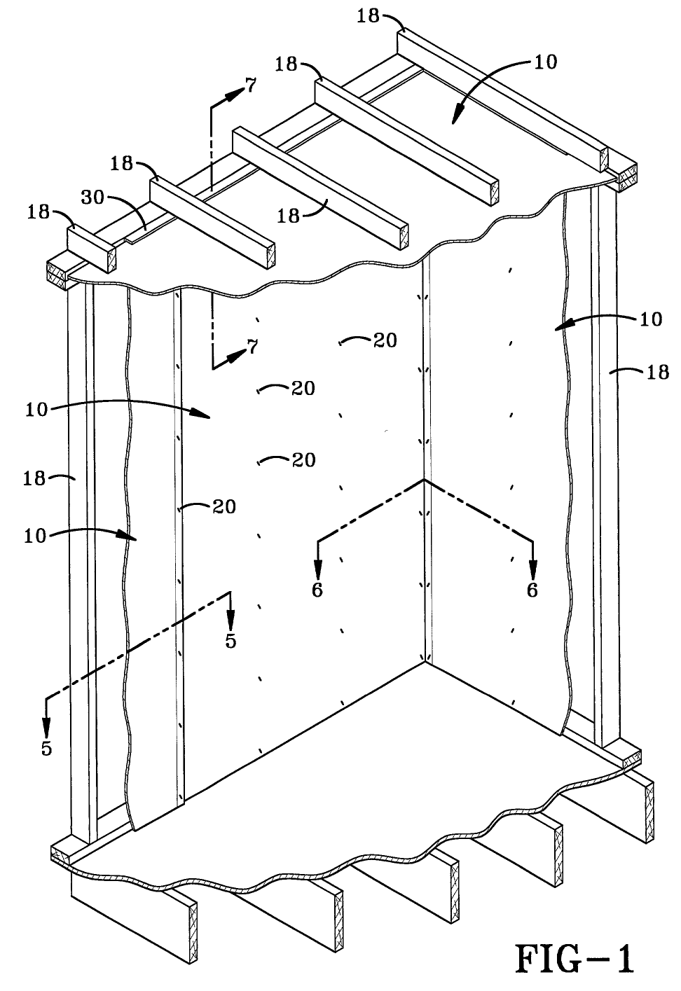

The first embodiment of the wall covering product of the present invention is indicated generally by the numeral 10 in FIGS. 1-7A. Wall covering 10 is generally fabricated in the form of panels formed from corrugated cardboard. The structure of the cardboard may be best seen in FIG. 2A. Each panel of wall covering 10 includes a first face 12, a second face 14, and an interior corrugation layer 16. Wall covering 10 may be provided in a variety of thicknesses but it is preferred that each panel of wall covering 10 is approximately one-eighth inch thick. In other embodiments, the thickness may be one-quarter inch, three-eighths inch, or one-half inch. In still other embodiments, the thickness may be as great as one inch if such a thickness is desired for a particular application. Wall covering 10 is preferably treated with a fire retardant agent.

Wall covering 10 is used to cover studs 18 in rooms such as garages, basements, utility rooms, closets, crawl spaces, or attics. Wall coverings 10 may also be used in rooms such as bedrooms, living rooms, kitchens, etc. Wall covering 10 provides a clean, smooth, aesthetically pleasing covering to studs 18. Wall covering 10 provides these benefits while being extremely easy to bring home from the store, install, and clean up after. Each panel 10 is light weight, may be cut with a utility knife or scissors, or may be hung to studs 18 with simple connectors such as the staples 20 depicted in the drawings. In other embodiments of the invention, nails, screws, or other types of penetrating connectors may be used in place of staples 20. In still other embodiments, panels 10 may be glued or otherwise adhered to studs 18. Other types of connectors are also envisioned such as interference fit connectors. These may include clips or velcro.

It may thus be understood that wall covering panels 10 are easily installed by the do-it-yourselfer. Each panel 10 may be measured, cut to length, and installed by a single person using a single staple gun. This process has numerous benefits over the drywalling process described above in the Background Information section of this application. The clean up is minimal because there is little dust and the scraps may be thrown out with household trash. The material may be recycled because it is fabricated from recyclable materials. Panels 10 may also be entirely fabricated from recycled materials. The result is a clean, bright, relatively smooth finish in a room that was previously bare studs against wall.

Another benefit with the installation process is that openings for electrical outlets, electrical switches, and overhead lights may be located by pressing on panels 10 after they are installed. The openings may then be cut with a simple utility knife. Still another benefit to wall covering product 10 is that a damaged panel 10 may be quickly and easily replaced with a new panel simply by pulling the damaged panel off of the wall or ceiling and stapling up a new panel. This is especially useful in areas that frequently encounter water damage. Each panel 10 may be finished by painting or wall papering as desired by the home owner.

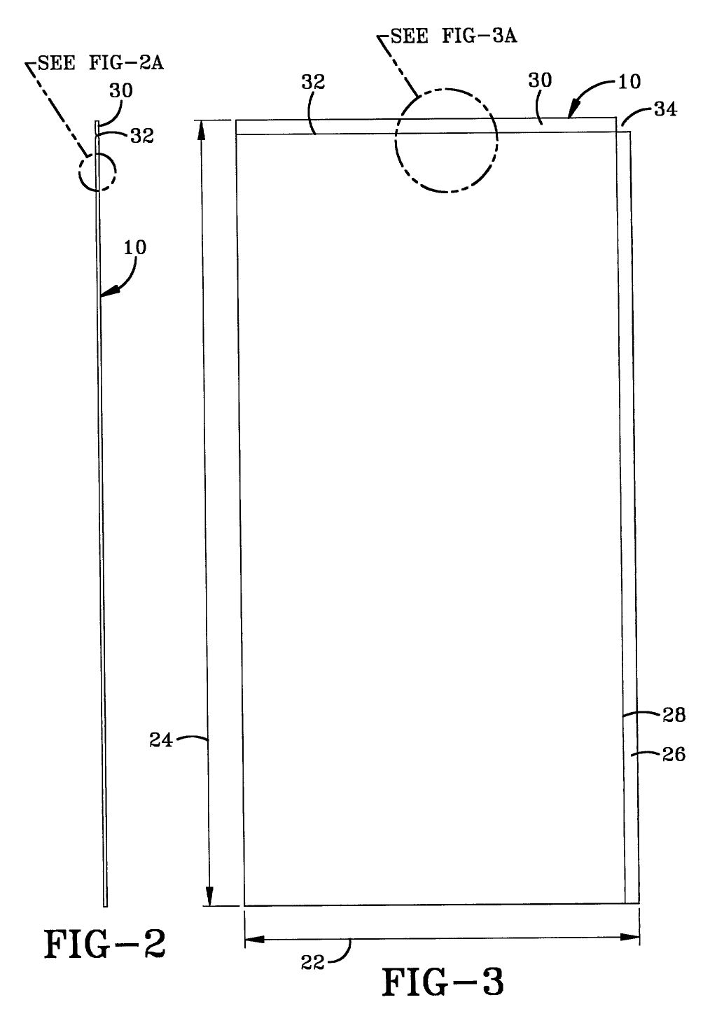

Having now described the benefits of wall covering 10, the structure will now be described. In the first embodiment of the present invention, each panel is preferably provided in an overall length of ninety-seven inches and an overall width of forty-nine inches. The width and length dimensions are depicted in FIG. 3. The width is indicated by the dimension 22 while the length dimension is indicated by the numeral 24. Panel 10 is forty-nine inches in width because it includes a flap 26 disposed along one edge of panel 10. Flap 26 is defined by a score line 28 that allows flap 26 to be readily folded with respect to the body of panel 10. In the preferred embodiment of the invention, flap 26 is one inch in width so that the body of panel 10 has a width of forty-eight inches. In other embodiments, flap 26 may be three-quarter inch with dimension 22 being forty-eight and one-quarter inch. Similarly, length 24 of panel 10 may include a flap 30 defined by a score line 32. Flap 30 and dimension 24 have the same relationship as the width of flap 26 and dimension 22. When panel 10 includes both flaps 26 and 30, the corner 34 where flaps 26 and 30 would overlap may be removed during the manufacturing process to allow flaps 26 and 30 to be readily folded by the person installing panels 10. Each score 28 and 34 may be formed during the manufacture of panel 10 and may have a depth ranging from about 0.025 to 0.035 inch to facilitate right-angled or lesser angled bending of flaps 26 and 30 away from the plane of the body of panel 10. Other score depths may also be used without departing from the concepts of the present invention. Each panel 10 optionally may be provided with one flap 26 or 30, or both flaps 26 and 30.

Each panel 10 may be formed with flaps such as 26 and 30 on all four sides of panel 10.

Product markings and product identification numbers may be placed along flaps 26 or 30 so that they are covered when product 10 is installed.

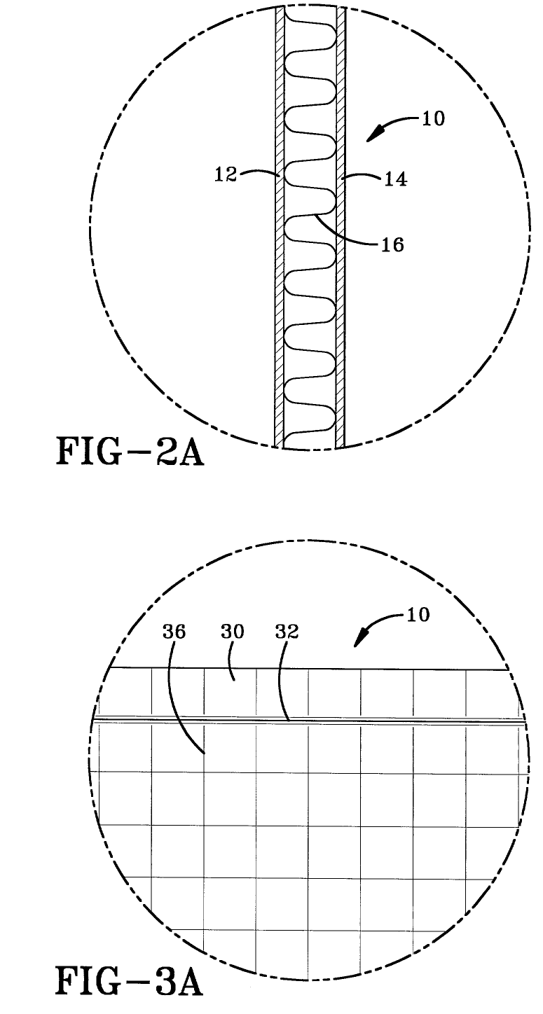

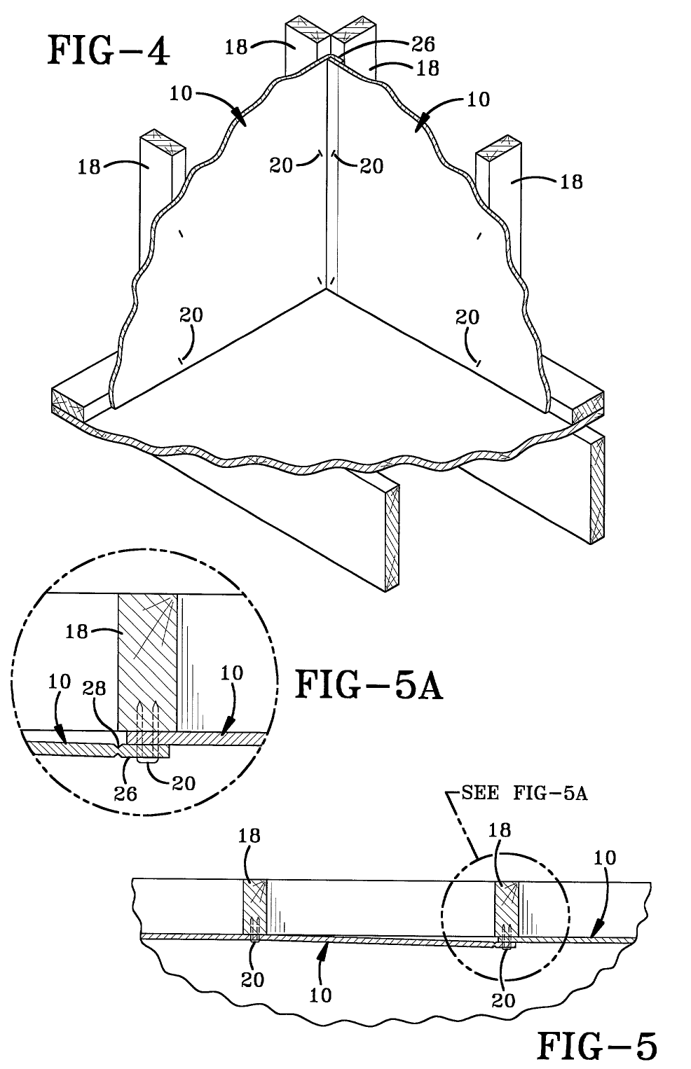

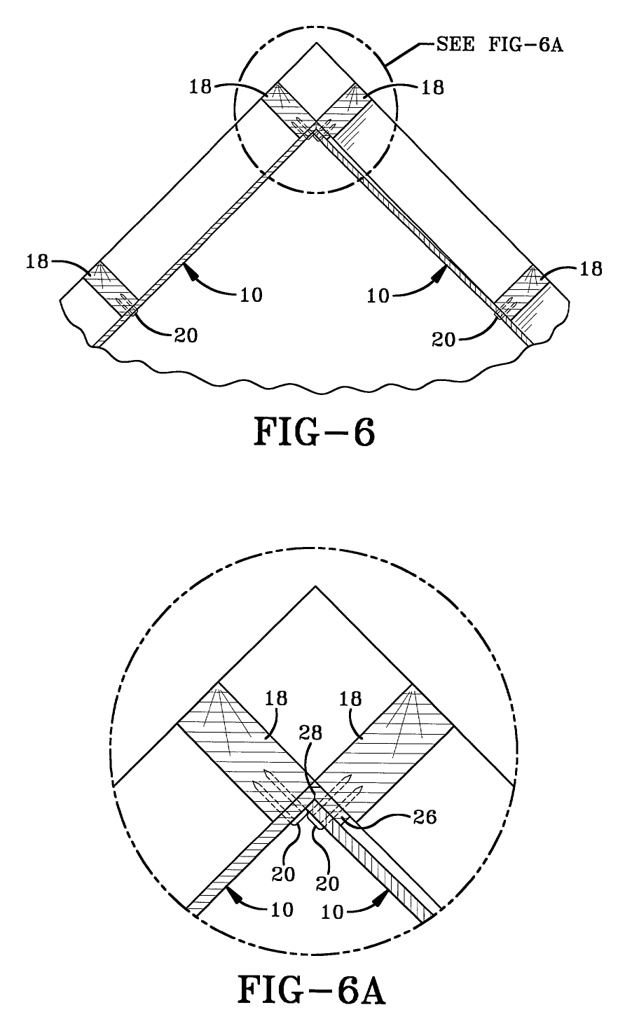

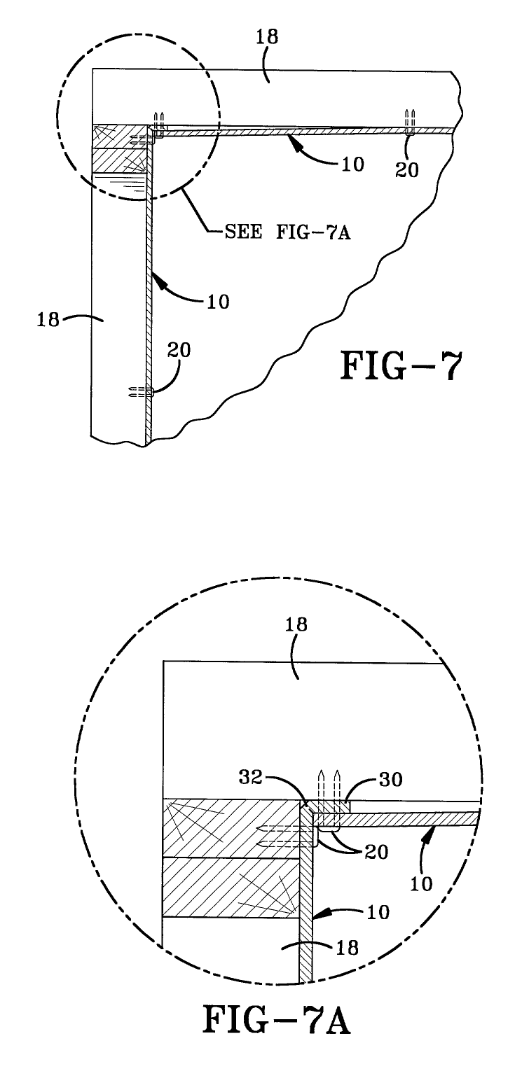

Flaps 26 and 30 are used primarily at corners as shown in FIGS. 4, 6, and 7. However, flaps 26 and 30 are also used at overlap joints as shown in FIGS. 5 and 5A. During installation, the person installing panels 10 first measures the 20 area that he wants to cover. The person installing panels 10 then cuts each panel 10 to the measured length and width. Panel 10 is then connected to studs 18 by appropriate connectors. If panel 10 is being installed at a corner, flap 26 is folded to a 90° angle as shown in FIG. 6 and flap 26 is stapled to stud 18 at the corner. The body of panel 10 is also stapled to a stud 18 as shown in FIG. 6A. The next adjacent panel is then placed over flap 26 and stapled through flap 26 and at the next adjacent stud as depicted in FIG. 6. This practice allows panel 10 to have a slight angle as it moves away from flap 26. Similarly, as shown in FIG. 7, flap 30 is folded to a 90° angle so that panels 10 installed in the ceiling may overlap flap 30 during the installation. Flaps 26 and 30 thus help form smooth, tight corner joints that lack gaps. In another installation method, flaps 26 and 30 may be folded at 90° angles and installed over adjacent panels instead of under adjacent panels. Score lines 28 and 32 allow the person installing panels 10 to easily and readily fold flaps 26 and 30 without using a bending edge. Flaps 26 or 30 may be cut away when not needed.

Another feature of wall covering 10 is depicted in FIG. 3A. At least one face 12 or 14 of wall covering 10 is provided with a grid pattern 36 that allows the person installing panel 10 to quickly measure dimensions on panel 10. Grid 36 may be provided in any of a variety of dimensions. For instance, each grid of grid pattern 36 may be a one inch square, a two inch square, a twelve inch square, etc. It is generally desired that grid pattern 36 be installed against studs 18 so that it is not visible after panel 10 is installed. It is also contemplated that a second grid pattern may be provided on the other face 12 or 14 in another dimension so that one side of panel may be marked at one inch squares with the other side of panel 10 being marked with twelve inch squares.

Each panel 10 is a relatively high strength laminated corrugated product that is adapted to be manufactured as corrugated paper liner board such as that employed in making corrugated boxes. Each panel 10 may have a thin metallic foil adhered to its exterior surface to provide water and fire resistant capabilities. Each panel 10 may be laminated with heat and fire proof adhesive materials that make the board moisture resistant for long term durable use in building construction. As shown in FIG. 2, the corrugations are in the direction of width dimension 22 such that corrugation 16 extend between studs 18 to provide strength to panel 10. Each panel 10 may be formed on a corrugated board forming machine known as a corrugator with corrugation 16 in the form of uniform sine waves having paper liner boards adhesively attached to the crown portions of the sine waves. FIG. 2A shows a greatly enlarged cross-sectional view of panel 10. Panel 10 may be treated with a water proofing resin such as product WP-23 provided by Allied Corr. Equip. Systems, Inc. of Cincinnati, Ohio. Panel 10 preferably utilizes a fire proof adhesive material to reduce the combustibility of panel 10.

In another embodiment of panel 10, the entire panel is fabricated from a fire resistant paper product such as the fire resistant paper available from Mead Corporation sold under Product No. BK810001. In this situation, panel 10 does not need to be treated with a fire proof coating or spray because the paper used to form panel 10 is fabricated to be fire retardant. It is desired that the result of a flame spread test will be below 25 and preferably as low as or lower than drywall when panel 10 is treated or built from fire retardant paper.

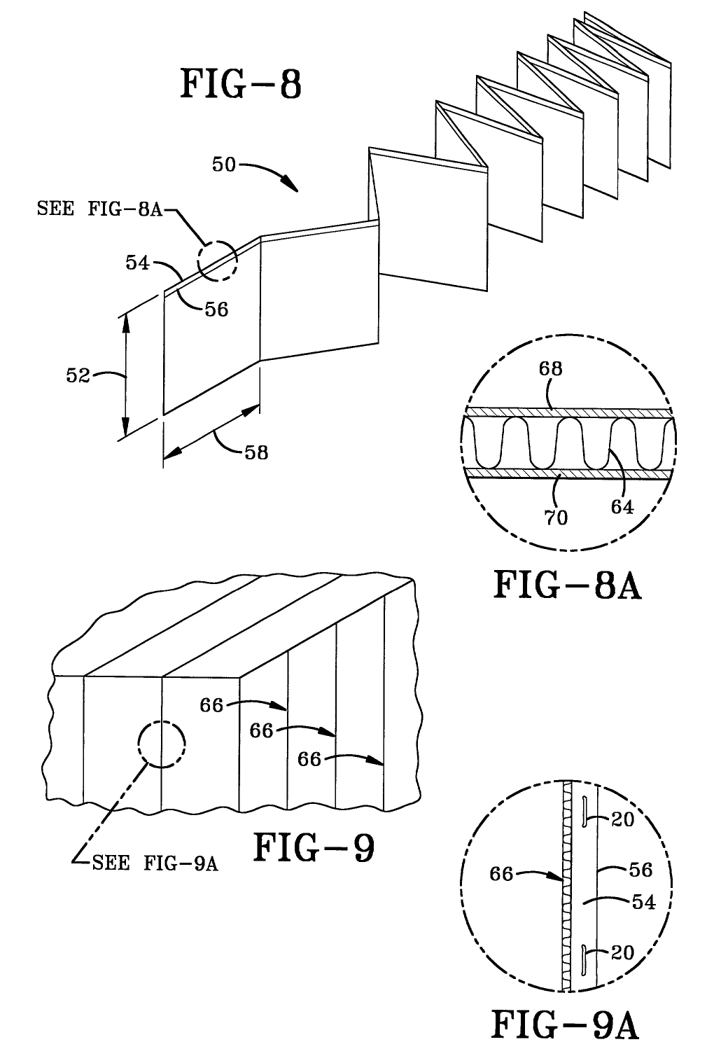

A second embodiment of the wall covering product of the present invention is indicated generally by the numeral 50 in FIGS. 8-9A. Wall covering 50 has substantially the same structure as described above with respect to wall covering 10. Wall covering 50 is, however, fabricated in long lengths such as thirty, fifty, or one hundred feet and fan-folded so that it may be packaged in a convenient package. Width dimension 52 is preferably forty-nine inches including a one inch flap 54 defined by a score line 56. In the preferred embodiments, wall covering 50 is folded at a fold dimension 58 of either two feet or four feet depending on the available equipment and desired application. It may thus be understood that wall covering 50 may be folded up into a compact package that will fit in a box 60 such as depicted in FIG. 10. Box 60 may have an opening 62 along one large face so that product 50 may be removed from box easily, cut to length, and box may be reclosed. Box 60 is small enough to fit in most family sized vehicles so that the person installing product 50 may purchase product 50 at a hardware store and readily transport box 60 back to his house. Wall covering 50 has the advantage that it may be used in tall rooms without creating horizontal seams in the walls as depicted in FIG. 9. Product 50 may also be used on ceilings as depicted in FIG. 9 without latitudinal seams as depicted in FIG. 9.

Another feature of product 50 (that also may be used with the other embodiments of the present invention) is that the corrugation layer 64 of product 50 is fabricated from white paper. This is important because the exposed edges 66 of product 50 may be seen when product 50 is installed. By fabricating corrugation layer 64 from white material, exposed edges 66 blend into the adjacent white panels. It is also preferred that faces 68 and 70 be fabricated from white paper. It is also desired to fabricate the entire structure of wall covering 50 from fire retardant paper such as Mead Paper Product BK81001. This structure provides acceptable results in a flame and smoke spread test. Product 50 may also be treated with a fire retardant spray or adhesive as well as a moisture resistant treatment.

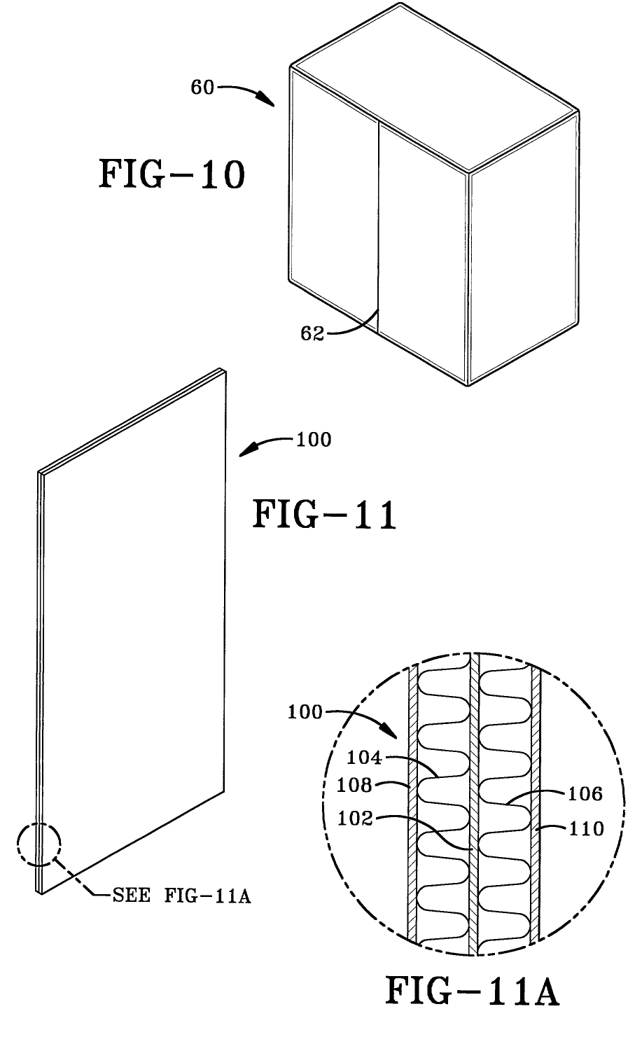

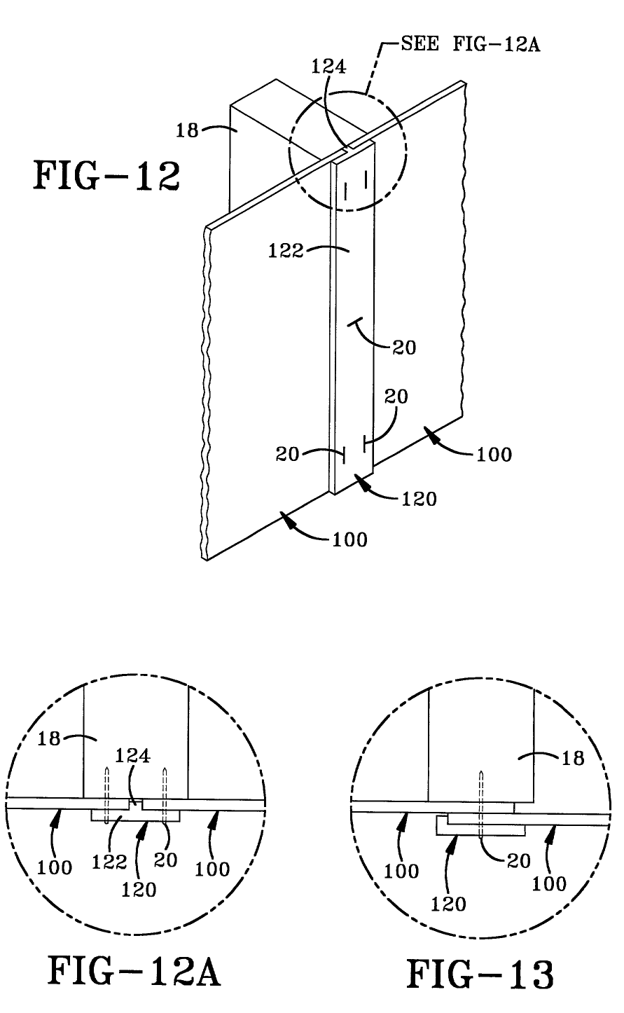

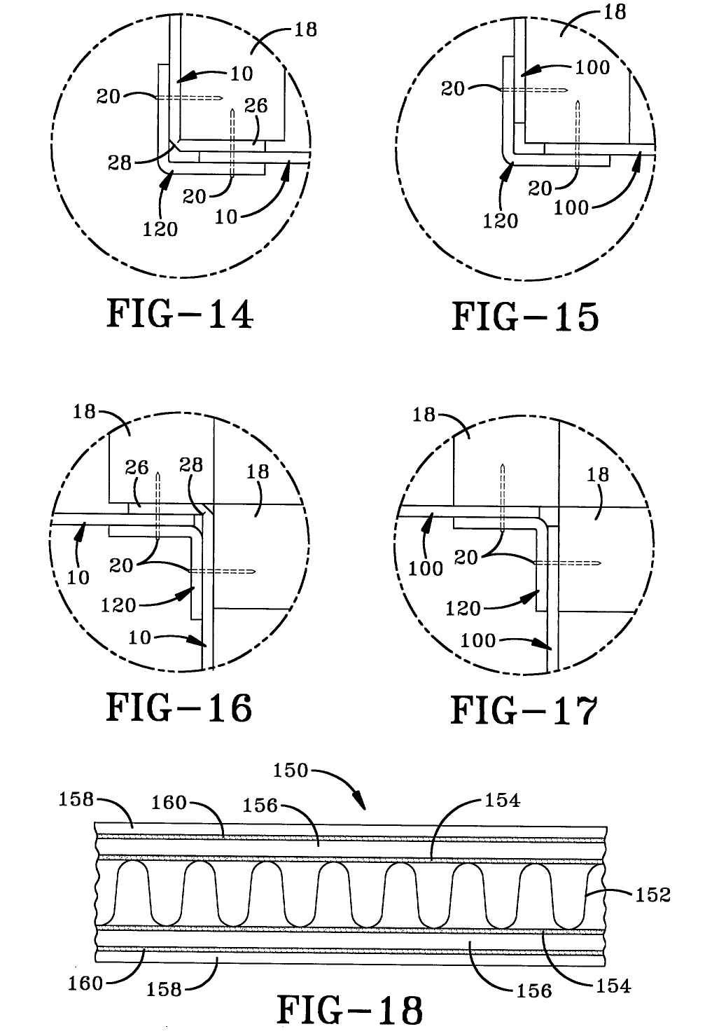

A third embodiment of the wall covering of the present invention is indicated generally by the numeral 100 in FIGS. 11 and 11A. Wall covering 100 is preferably provided in four foot by eight foot sheets. Wall covering 100 is also preferably double corrugated such that it includes an interior liner 102, a pair of corrugation layers 104 and 106 in addition to exterior liners 108 and 110. Wall covering 100 may be treated with fire retardant treatments, moisture resistant treatments, or may be fabricated from fire retardant paper as described above. Wall covering 100 is preferably attached to studs 18 by clips that extend into the body of wall covering 100 but do not penetrate entirely through wall covering 100 so that a clean, smooth finish is provided when wall coverings 100 are installed. The joints between adjacent wall coverings 100 may be covered by joint cover members 120 as shown in FIG. 12. Joint cover members 120 may have a broad flange 122 and a protrusion 124 that extends substantially perpendicularly away from flange 122. Protrusion 124 is configured to fit between adjacent sheets 100 allowing flange 122 to rest against the outer surfaces of sheets 100. Staples 20 are then used to hold members 120 in place. Joint cover members 120 are preferably opaque but may be clear if desired. Alternatively, a glue may be used to hold members 120 to sheets 100. Further embodiments of joint cover members are depicted in FIGS. 13-17.

A fourth embodiment of a wall covering member according to the present invention is indicated generally by the numeral 150 in FIG. 18. The structure of member 150 may be used with any of the embodiments described above. Structure 150 is especially useful for being resistant to flames. Structure 150 includes an interior corrugation layer 152 that is secured by an adhesive 154 to liner boards 156. Each liner board 156 is adhered to an aluminum layer 158 by an appropriate adhesive 160. Each liner board 156 may be treated with a fire proof treating on its outer surface. This structure results in a panel that has an extremely low flame spread and smoke spread rating. The structure may be used with any of the embodiments described above. The structure 150 may also be used with aluminum 158 disposed on only one side instead of both sides.

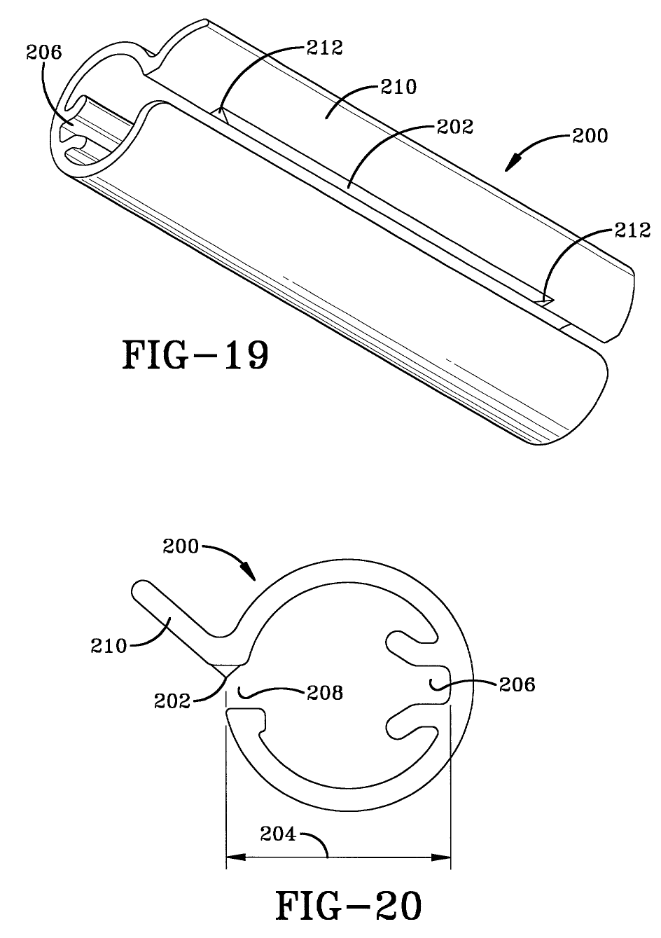

A scoring tool is depicted in FIGS. 19 and 20 and is indicated generally by the numeral 200. Tool 200 is used to create score lines such as line 28 of FIG. 3, line 32 of FIG. 3A, or line 56 of FIG. 8. Tool 200 includes a scoring tip 202 positioned a scoring distance 204 from the bottom edge of a channel 206. Channel 206 is aligned with an opening 208 adjacent scoring tip 202. A piece of paneling or board is inserted through opening 208 and into channel 206 so that scoring tip 202 presses against one surface of the paneling or board member. Scoring tool 200 is then moved along the edge of the board or panel so that tip 202 creates a score line at score distance 204 from the edge received in channel 206. Tool 200 is preferably fabricated from extruded plastic or metal and cut to length as desired. A handle 210 is provided to allow the user to readily grip tool 200 and to apply the proper amount of pressure to score tip 202. Score tip 202 also has angled ends 212 to facilitate the motion along the board or panel.

Each of these embodiments provides a wall covering that is relatively light weight so that it may be easily installed by a single person as an alternative to drywall. The products are fire and moisture resistant. The products are easy to install and require little cleanup during installation. The products may be painted or wall papered after they are installed. Once installed, the panels may be easily replaced if damaged. The panels may be fabricated from recycled products and may be recycled when removed from a room.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A panel of wall covering material for extending between the studs of a framed wall or ceiling in a room in order to provide a clean, smooth appearance to a person in the room; the panel of wall covering comprising:
a body having four edges;
the body having a first face, a second face, and a corrugation layer disposed between the first and second faces;
a first flap connected to the body along a first edge, the first flap being defined by a first score line;
the first flap being foldable with respect to the body; and
the body being adapted to be mounted between the studs to function as a wall covering.

2. The panel of claim 1, further comprising a second flap connected to the body along a second edge, the second flap being defined by a second score line.

3. The panel of claim 2, wherein the first score line is substantially perpendicular to the second score line.

4. The panel of claim 3, wherein one of the flaps has a width of 1 inch.

5. The panel of claim 1, wherein the body has a length of 96 inches and a width of 48 inches.

6. The panel of claim 5, wherein the first flap has a width of 1 inch.

7. The panel of claim 1, wherein the corrugation layer is colored white.

8. The panel of claim 1, wherein at least one of the first and second faces of the body includes a grid pattern.

9. The panel of claim 1, wherein at least one of the first panel, the second panel, and the corrugation layer is treated with a flame retardant.

10. The panel of claim 1, wherein at least of the faces is covered with a thin metallic foil.

11. The panel of claim 1, wherein the corrugations extend in the width direct so that the corrugations are adapted to extend between studs when the panel is installed.

12. The panel of claim 1, wherein the body and flap are fabricated from a fire resistant paper.

13. The panel of claim 1, wherein the body is folded accordion-style.

14. The panel of claim 13, wherein the length of the body is greater than 8 feet.

15. The panel of claim 14, wherein the length of the body is greater than 16 feet.

16. The panel of claim 1, wherein each face is connected to an aluminum layer.

17. The panel of claim 16, wherein each face is treated with a fire proof treatment.

18. A panel of wall covering material for extending between the studs of a framed wall or ceiling in a room in order to provide a clean, smooth appearance to a person in the room; the panel of wall covering comprising:
a body having four edges;
the body having a first face, a second face, and a pair of corrugation layers disposed between the first and second faces; and
the body being adapted to be mounted between the studs to function as a wall covering.

19. The panel of claim 18, further comprising a joint cover member adapted to be connected to the body adjacent an edge of the body; the joint cover member including a flange and a protrusion disposed substantially perpendicularly to the flange.

20. A tool for creating a score line on a panel; the tool comprising
a handle defining a channel;
a scoring tip connected to the handle;
the scoring tip extending at least partially into the channel.
